(19) United States
(12) Patent Application Publication
(10) Pub. No.: US 2017/0364394 A1
(43) Pub. Date: Dec. 21, 2017

(54) SYSTEM AND METHOD TO PERFORM LIVE MIGRATION OF A VIRTUAL MACHINE WITHOUT SUSPENDING OPERATION THEREOF

(71) Applicant: FUJITSU LIMITED, Kawasaki-shi (JP)

(72) Inventor: TOMOYA FUJITA, Sagamihara (JP)

(73) Assignee: FUJITSU LIMITED, Kawasaki-shi (JP)

(21) Appl. No.: 15/614,929

(22) Filed: Jun. 6, 2017

(30) Foreign Application Priority Data
Jun. 20, 2016 (JP) 2016-121797

(51) Int. Cl. G06F 9/50; G06F 9/48; G06F 9/455

(52) U.S. Cl. CPC G06F 9/5088; G06F 9/4856; G06F 9/45558; G06F 2009/4557; G06F 9/50

(57) ABSTRACT

First and second machines include first and second memories, respectively, and are accessible to a shared memory. The first machine executes copying data stored in the first memory allocated to the virtual machine to the shared memory, and translates a physical address for the virtual machine to access to the data, from an address of the first memory to an address of the shared memory. When copying of all data in the first memory to the shared memory completes and the first machine changes over control of the virtual machine from the first machine to the second machine, the second machine executes copying the data stored in the shared memory to the second memory allocated to the virtual machine, and translates a physical address for the virtual machine to access the data, from an address of the shared memory to an address of the second memory.

### CROSS-REFERENCE TO RELATED APPLICATION

This application is based upon and claims the benefit of priority of the prior Japanese Patent Application No. 2016-121797, filed on Jun. 20, 2016, the entire contents of which are incorporated herein by reference.

### FIELD

The embodiments discussed herein are related to system and method to perform live migration of a virtual machine without suspending operation thereof.

### BACKGROUND

There is a method called cold migration as a migration method that migrates a virtual machine operating on a physical machine to another physical machine. In the cold migration, a virtual machine in a suspended state is migrated, and therefore information of a memory used by the virtual machine on the physical machine of the migration source does not have to be transferred. Thus, virtualization management software transmits only configuration information of the virtual machine to a physical machine of the migration destination, and activates the virtual machine on the physical machine of the migration destination. The cold migration stops the virtual machine during a maintenance work, and does not allow the virtual machine to continuously perform task operations.

Meanwhile, computer systems adopting virtualization such as UNIX (registered trademark) and Intel Architecture (IA) have a live migration function. The live migration is a migration method that migrates a virtual machine while allowing the virtual machine to perform the task operation as continuously as possible. In the live migration, after memory information of the virtual machine is transmitted from the migration source to the migration destination by using a network and is copied into a memory of a physical machine of the migration destination, the operation of the virtual machine is changed over from the migration source to the migration destination.

In connection with such live migration, for example, there is a proposal of a system that synchronizes a virtual machine of a migration-source physical host and a virtual machine of a migration-destination physical host with each other by transmitting memory data of the virtual machine from the migration-source physical host to the migration-destination physical host. In this system, whether data synchronization with each virtual machine of the migration-source physical host is completed is determined. Then, as a result, when all the virtual machines are determined as completing the data synchronization, the virtual machines are changed over from the migration-source physical host to the migration-destination physical host. Data of the memory is transmitted continuously until the changeover instruction is given.

Also, there is a proposal of a technique that uses a shared memory for migration. For example, a system has been proposed for a migration of a first virtual computer which includes an operating system and an application in a first private memory private to the first virtual machine. In this system, a communication queue of the first virtual machine resides in a shared memory shared by first and second computers or first and second logical partitions (LPARs). The operating system and application are copied from the first private memory to the shared memory. The operating system and application are copied from the first private memory to the shared memory. Thereafter, the operating system and application are copied from the shared memory to a second private memory private to the first virtual machine in the second computer or second LPAR. Then, the first virtual machine is resumed in the second computer or second LPAR.

Related techniques are disclosed in, for example, International Publication Pamphlet No. WO 2014/010213 and Japanese Laid-open Patent Publication No. 2005-327279.

### SUMMARY

According to an aspect of the invention, a system includes a first physical machine including a first local memory, a second physical machine including a second local memory, and a shared memory accessible from both of the first physical machine and the second physical machine. The first physical machine executes processing of copying data stored in the first local memory allocated to the virtual machine to the shared memory, and translates a physical address for the virtual machine to access to the data copied from the first local memory to the shared memory, from an address of the first local memory to an address of the shared memory. When copying of all data in the first local memory to the shared memory completes and the first physical machine changes over control of the virtual machine from the first physical machine to the second physical machine, the second physical machine executes processing of copying the data stored in the shared memory to the second local memory allocated to the virtual machine, and translates a physical address for the virtual machine to access the data copied from the shared memory to the second local memory, from an address of the shared memory to an address of the second local memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a control system, according to an embodiment;

FIG. 2 is a diagram illustrating an example of an address translation table, according to an embodiment;

FIG. 3 is a diagram illustrating an example of a hardware configuration of a control system, according to an embodiment;

FIG. 4 is a diagram illustrating an example of an operational flowchart for entire live migration processing executed by a control system, according to an embodiment;

FIG. 5 is a diagram illustrating an example of an operational flowchart for migration source processing and migration destination processing, according to an embodiment;

FIG. 6 is a diagram illustrating an example of an operational flowchart for copy processing to a shared memory, according to an embodiment;

FIG. 7 is a diagram illustrating an example of copying and address translation from a local memory of a migration source to a shared memory, according to an embodiment;

FIG. 8 is a diagram illustrating an example of address rewriting in an address translation table, according to an embodiment;

FIG. 9 is a diagram illustrating an example of an operational flowchart for copy processing from a shared memory, according to an embodiment;

FIG. 10 is a diagram illustrating an example of copying and address translation from a shared memory to a local memory of a migration destination, according to an embodiment;

FIG. 11 is a diagram illustrating an example of a configuration of a control system, according to an embodiment;

FIG. 12 is a diagram illustrating an example of a hardware configuration of a control system, according to an embodiment;

FIG. 13 is a diagram illustrating an example of a configuration of a CPU chip, according to an embodiment;

FIG. 14 is a diagram illustrating an example of an operational flowchart for migration source processing and migration destination processing, according to an embodiment;

FIG. 15 is a diagram illustrating an example of a configuration of a control system, according to an embodiment;

FIG. 16 is a diagram illustrating an example of an operational flowchart for migration source processing and migration destination processing, according to an embodiment;

FIG. 17 is a diagram illustrating an example of dirty page tracking;

FIG. 18 is a diagram illustrating an example of a case where suspension occurs during a live migration; and

FIG. 19 is a diagram illustrating an example of a case where suspension occurs during a live migration.

### DESCRIPTION OF EMBODIMENTS

During the live migration, the memory information of the virtual machine is constantly updated as the virtual machine is operating. Therefore, it is impossible to make the live migration source and the live migration destination hold the exactly the same memory information unless the virtual machine is suspended. In other words, when migrating the virtual machine by the live migration, the virtual machine has to be suspended inevitably for transferring the memory information to the live migration destination, and this does not allow the virtual machine to continually perform the task operation.

It is desirable to execute live migration without suspending a virtual machine.

Hereinafter, an example of embodiments of the disclosed technique is described in detail with reference to the accompanying drawings.

Before describing details of the following respective embodiments, description is provided for suspension of a virtual machine during a live migration. The live migration is a method that migrates a virtual machine while allowing the virtual machine to perform its task operation as continuously as possible. However, the conventional live migration requests suspension of the virtual machine although for a short time.

In the live migration of the virtual machine, a hypervisor copies data of a memory (hereinafter referred to as “virtual machine memory”) allocated to a virtual machine in a physical machine of the migration source into a virtual machine memory of the migration destination. Data to be copied is commonly transferred from a physical machine of the migration source to a physical machine of the migration destination by data transfer via network. As the virtual machine is operating during live migration, the data in the virtual machine memory is updated from time to time by an application operating on the virtual machine even during the data transfer.

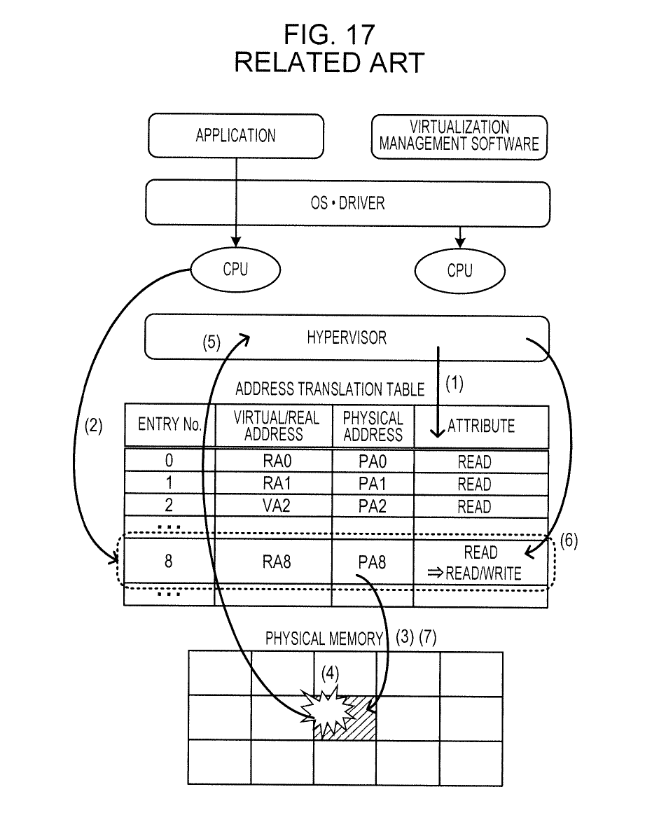

Using the dirty page tracking function, the hypervisor detects a virtual machine memory (dirty page) whose data is updated during live migration. Specifically, as illustrated in FIG. 17, when dirty page tracking is started, the hypervisor changes the attribute of all entries in the address translation table to the attribute (“READ”) allowing only reading ((1) of FIG. 17). The address translation table is a table that stores the virtual address (VA)/real address (RA) and physical address (PA) associated with each other for each of entries corresponding blocks into which each of the memories is divided. Each entry also stores an attribute of access allowable to the corresponding block.

Then, when a central processing unit (CPU) writes data into an area of a physical memory associated with an entry 8 ((2) and (3) of FIG. 17), a trap occurs since the attribute of the associated memory area is “READ” ((4) of FIG. 17). The hypervisor is notified of the trap ((5) of FIG. 17), and changes the attribute of the associated entry in the address translation table to an attribute (“READ/WRITE”) allowing writing as well ((6) of FIG. 17). Then, the hypervisor causes the CPU to retry writing into the memory ((7) of FIG. 17). The hypervisor detects the memory area updated in (7) as a dirty page. The hypervisor synchronizes data of the virtual machine memory between the migration source and migration destination by repeating data transfer of the dirty page.

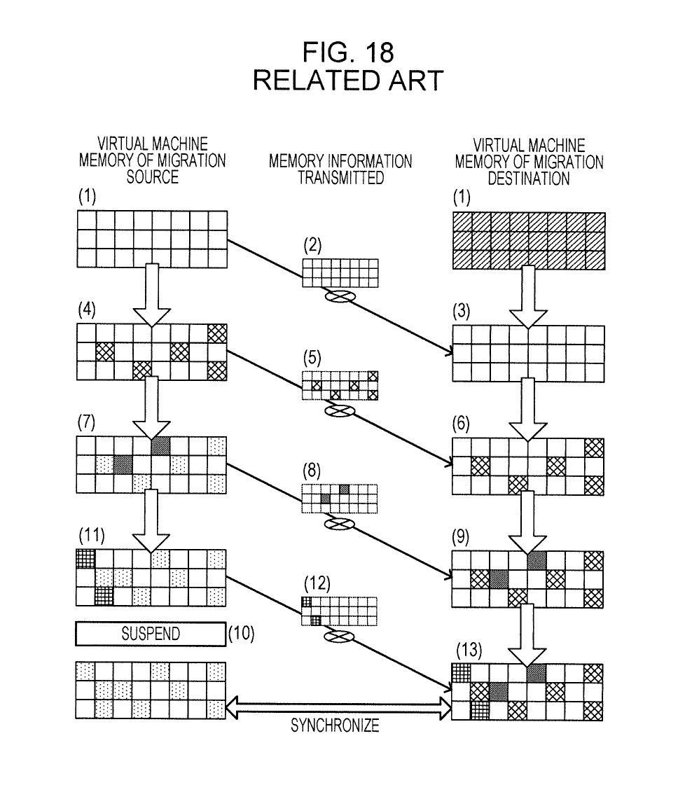

With reference to FIG. 18, data transfer during live migration is described more in detail by using an example where update processing speed of the virtual machine memory at the live migration source does not exceed an upper limit of a network bandwidth where data is transferred.

(1) of FIG. 18 indicates the state of each virtual machine memory of the migration source and migration destination prior to data transfer. The hypervisor transfers all data of the virtual machine memory of the migration source to the migration destination ((2) of FIG. 18). Then, the hypervisor copies transferred data into a virtual machine memory of the migration destination ((3) of FIG. 18). Even during this data transfer, the virtual machine of the migration source is operating. Thus, a portion of the virtual machine memory of the migration source is updated ((4) of FIG. 18). More specifically, data newer than data transferred to the migration destination in (2) is written into the virtual machine memory of the migration source. Then, the hypervisor transfers data of a memory updated in (4) or data of a memory updated after data transfer in (2) to the migration destination ((5) of FIG. 18) and copies into a memory of the migration destination ((6) of FIG. 18).

Even during data transfer of (5), a portion of the virtual machine memory of the migration source is updated ((7) of FIG. 18). Thus, the hypervisor repeats data transfer ((8) of FIG. 18) and copying ((9) of FIG. 18) of the difference to the memory of the migration destination. The hypervisor, for example, repeats data transfer of the updated virtual machine memory until the difference of the virtual machine memory between the migration source and migration destination becomes smaller than a predetermined value. When the difference between the virtual machine memories becomes smaller than the predetermined value, the hypervisor suspends the virtual machine of the migration source ((10) of FIG. 18). Thus, updating processing of the virtual machine memory of the migration source is stopped temporarily. Then, finally, the hypervisor transfers data of the memory updated between data transfer of (8) and suspension of (10) ((11) of FIG. 18) to the migration destination ((12) of FIG. 18) and copies into a memory of the migration destination ((13) of FIG. 18). Thus, data of virtual machine memories of the migration source and migration destination fully synchronize with each other, and live migration completes when the virtual machine is resumed at the migration destination.

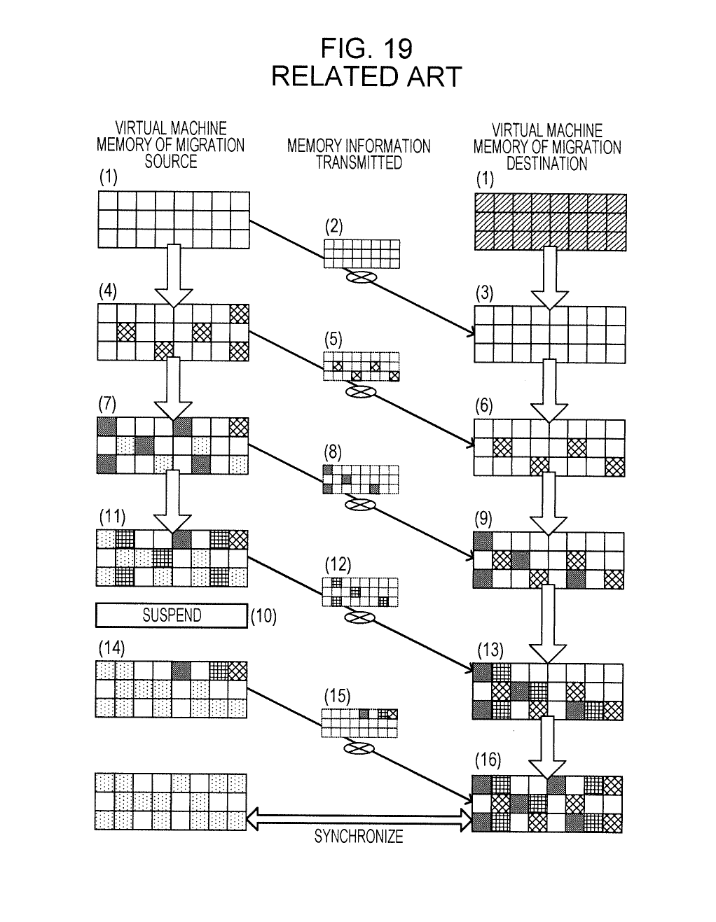

Next, with reference to FIG. 19, data transfer during live migration is described more in detail by using an example where update processing speed of the virtual machine memory at the live migration source exceeds the upper limit of the network bandwidth where data is transferred.

In the example of FIG. 19, for example, it is assumed that the network bandwidth is 10 Gbps, and transfer rate of 2.5 Gbps is requested for one block (each mass of the virtual machine memory of FIG. 19) of the virtual machine memory. Specifically, the environment is assumed to just allow transfer of data of at most four blocks for one second.

(1) to (4) are the same as those of FIG. 18. However, in the example of FIG. 19, data updating speed is higher than data transfer rate. For this reason, only data of some blocks (in the example of FIG. 19, four blocks out of five blocks) of the virtual machine memory whose data is updated in (4) is transferred ((5) of FIG. 19) and copied to a virtual memory of the migration destination ((6) of FIG. 19).

Even during data transfer of (5), as a portion of the virtual machine memory of the migration source is updated ((7) of FIG. 19), the hypervisor repeats data transfer ((8) of FIG. 19) and copying ((9) of FIG. 19) of the difference to the virtual machine memory of the migration destination. In the same manner as above, only data of some blocks of the virtual machine memory whose data updated in (7) is transferred. Therefore, the difference of data between virtual machine memories is not reduced even if data transfer processing is repeated. More specifically, synchronizing of virtual machine memories between the migration source and migration destination does not proceed.

Then, upon detecting that the updating speed of the virtual machine memory of the migration source is higher than the data transfer rate as illustrated in FIG. 19, the hypervisor suspends the virtual machine of the migration source ((10) of FIG. 19). Thus, updating processing of the virtual machine memory of the migration source is stopped temporarily. Then, the hypervisor transfers data ((11) of FIG. 18) of the memory updated between data transfer of (8) and suspension of (10) to the migration destination ((12) of FIG. 19) and copies into a virtual machine memory ((13) of FIG. 19). Also, the hypervisor transfers data ((14) of FIG. 19) not yet transferred to the migration destination, the data out of the memory updated in (4), (7), and (11), to the migration destination ((15) of FIG. 19) and copies into a virtual machine memory ((16) of FIG. 19).

Thus, data of virtual machine memories of the migration source and migration destination fully synchronize with each other, and live migration completes by resuming the virtual machine at the migration destination.

In both of the above examples, live migration of conventional virtual machines suspends the virtual machine although for a short time, and thereby does not allow continuous operation of service using the virtual machine during the period of stoppage.

The hypervisor determines a timing of suspending the virtual machine of the migration source based on a dirty ratio (ratio of the dirty page relative to entire memory) calculated by the dirty page tracking function. There is also a problem of the overhead in detection of the dirty ratio.

According to the embodiments described below, in live migration of the virtual machine, the virtual machine of the migration source is migrated to the migration destination without suspending the virtual machine. Hereinafter, the embodiments are described in detail.

### FIRST EMBODIMENT

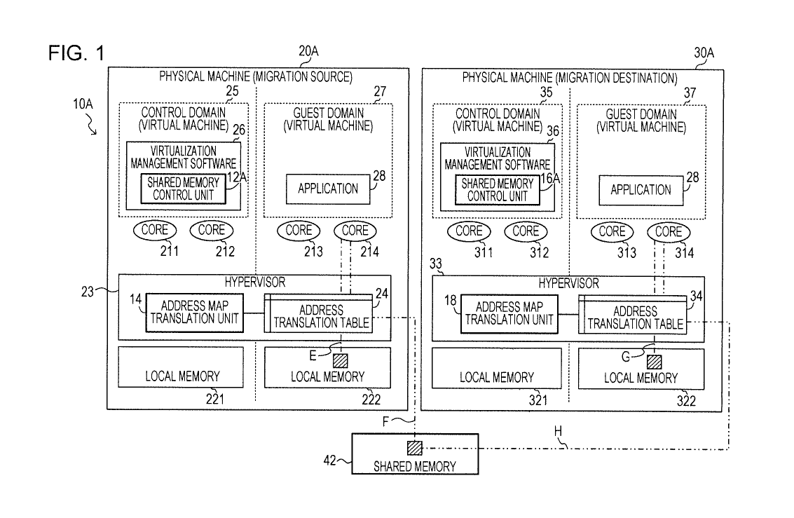

FIG. 1 schematically illustrates a functional configuration of a control system 10A according to a first embodiment, along with a relevant hardware configuration. As illustrated in FIG. 1, the control system 10A according to the first embodiment includes a physical machine 20A of the migration source, a physical machine 30A of the migration destination, and a shared memory 42.

In the physical machine 20A, a hypervisor 23 operates. The hypervisor 23 implements a virtual machine 25 as a control domain and a virtual machine 27 as a guest domain by using cores 21n (in FIG. 1, n=1, 2, 3, 4) of the CPU and local memories 22n (in FIG. 1, n=1, 2). FIG. 1 illustrates an example in which a core 211, a core 212, and a local memory 221 are allocated to the virtual machine 25, and a core 213, a core 214, and a local memory 222 are allocated to the virtual machine 27. FIG. 1 illustrates an example of one virtual machine 27 as a guest domain. However, a plurality of virtual machines 27 may be provided as a guest domain.

In the virtual machine 25 as a control domain, a virtualization management software 26 operates. The virtualization management software 26 manages a virtualization environment implemented on the physical machine 20A by using the hypervisor 23. The virtualization management software 26 incorporates therein a shared memory control unit 12A as a function unit. The shared memory control unit 12A controls acquisition and release of the memory area of the shared memory 42 during live migration (details are described below).

The virtual machine 27 as a guest domain is a virtual machine which is the target of live migration in this embodiment. In the virtual machine 27, an application 28 is executed. When a core 21n accesses to a memory by specifying the virtual/real address in accordance with instruction of the application 28, the hypervisor 23 translates the virtual/real address to the physical address by referring to an address translation table 24. Thus, the core 21n accesses to given data.

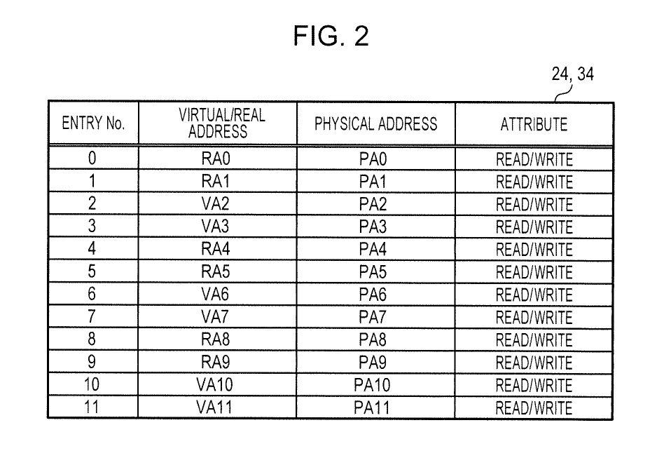

FIG. 2 illustrates an example of the address translation table 24. In the example of FIG. 2, each of blocks into which the memory area of the physical machine 20A is divided by a predetermined unit (for example, 8 kB) is set as one entry, and the address translation table 24 stores the virtual/real address and the physical address in association with each other for each entry. The address translation table 24 also stores an attribute in association with each entry, the attribute indicating whether to allow only reading of the block for the entry (“READ”) or whether to allow reading and writing thereof (“READ/WRITE”).

The hypervisor 23 incorporates therein an address map translation unit 14 as a function unit. During live migration, the address map translation unit 14 translates a physical address associated with a virtual/real address in the address translation table 24 from the address of a local memory 22n to the address of a shared memory 42 (details are described below).

In the physical machine 30A, a hypervisor 33 operates as in the physical machine 20A. The hypervisor 33 implements a virtual machine 35 as a control domain and a virtual machine 37 as a guest domain by using cores 31n (in FIG. 1, n=1, 2, 3, 4) of the CPU and local memories 32n (in FIG. 1, n=1, 2). FIG. 1 illustrates an example in which a core 311, a core 312, and a local memory 321 are allocated to the virtual machine 35, and a core 313, a core 314, and a local memory 322 are allocated to the virtual machine 37. FIG. 1 illustrates an example of one virtual machine 37 as a guest domain. However, the number of virtual machines 27 as a guest domain may be two or more.

In the virtual machine 35 as a control domain, a virtualization management software 36 operates. The virtualization management software 36 includes a shared memory control unit 16A as a function unit. The shared memory control unit 16A notifies the shared memory control unit 12A of the migration source of completion of copying of the data from a shared memory 42 to the local memory 32n in the live migration (details are described below).

The virtual machine 37 as a guest domain is a virtual machine which is implemented in the physical machine 30A of the migration destination based on the same configuration information as the virtual machine 27 of the migration source. In the virtual machine 37, an application 28 is executed as in the virtual machine 27 of the migration source. When a core 31n accesses to a memory by specifying the virtual/real address in accordance with the instruction from the application 28, the hypervisor 33 translates the virtual/real address to the physical address by referring to the address translation table 34. Thus, the core 31n accesses given data. Data structure of the address translation table 34 is, for example, the same as the address translation table 24 as illustrated in FIG. 2.

The hypervisor 33 incorporates therein an address map translation unit 18 as a function unit. During the live migration, the address map translation unit 18 translates a physical address associated with a virtual/real address in the address translation table 34 from the address of the shared memory 42 to the address of the local memory 32n (details are described below).

In this embodiment, the shared memory control unit is described by separating a part functioning at the migration source (shared memory control unit 12A) and a part functioning at the migration destination (shared memory control unit 16A) from each other for the convenience of description. In the same manner, the address map translation unit is described by separating a part functioning at the migration source (address map translation unit 14) and a part functioning at the migration destination (address map translation unit 18) from each other. However, each of the shared memory control units and address map translation units may include both the part functioning at the migration source and the part functioning at the migration source. In this case, a requested function may be executed depending on whether a physical machine in which the shared memory control unit and the address map translation unit are incorporated is at the migration source or at the migration source.

The shared memory control unit 12A is an example of a first control unit of the disclosed technique, the address map translation unit 14 is an example of a first translation unit of the disclose technique, the shared memory control unit 16A is an example of a second control unit of the disclosed technique, and the address map translation unit 18 is an example of a second translation unit of the disclosed technique.

The shared memory 42 is a memory accessible from a plurality of nodes. Here, each of nodes is each of virtual machines operating on a different operating system (OS) in the same physical machine or in a different physical machine. The plurality of nodes accessible to the shared memory 42 include not only different virtual machines operating on the same physical machine but also a plurality of virtual machines operating on different physical machines. In this embodiment, the shared memory 42 is a memory accessible from both the virtual machine 27 on the physical machine 20A and the virtual machine 37 on the physical machine 30A.

For example, a core 214 allocated to the virtual machine 27 on the physical machine 20A may directly access the local memory 222 allocated to the virtual machine 27 (one-dot broken line E of FIG. 1). In addition, the core 214 also may directly access the shared memory 42 existing outside the control system 10A (double-dot broken line F of FIG. 1). Likewise, a core 314 allocated to the virtual machine 37 on the physical machine 30A may directly access a local memory 322 allocated to the virtual machine 37 (one-dot broken line G of FIG. 1). In addition, the core 314 may also directly access the shared memory 42 existing outside the control system 10A (double-dot broken line H of FIG. 1).

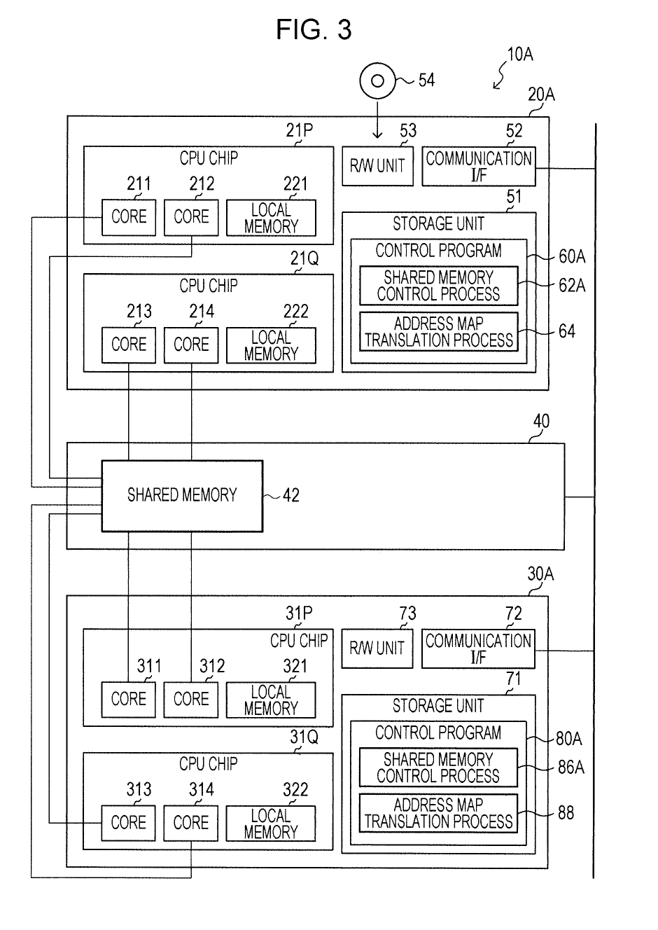

FIG. 3 is a schematic view illustrating a hardware configuration of the control system 10A according to the first embodiment.

The physical machine 20A includes a CPU chip 21P including a core 211, a core 212, and a local memory 221, and a CPU chip 21Q including a core 213, a core 214, and a local memory 222. A core 21n may directly access a local memory 22n mounted in the same chip, and the shared memory 42.

The physical machine 20A also includes a nonvolatile storage unit 51, a communication interface (I/F) 52, read/write (R/W) unit 53 that controls reading and writing of data into a storage medium 54. CPU chips 21P, 21Q, the storage unit 51, the communication I/F 52, and the R/W unit 53 are coupled with each other via a bus.

The storage unit 51 may be implemented by a hard disk drive (HDD), a solid state drive (SSD), or a flash memory. The storage unit 51 as a storage medium stores a control program 60A executed during the live migration of the virtual machine. The control program 60A includes a shared memory control process 62A and an address map translation process 64.

Cores 211, 212 allocated to the virtual machine 25 as a control domain reads the control program 60A from the storage unit 51, develops the same on the local memory 221, and executes processes of the control program 60A sequentially. The cores 211, 212 operate as a shared memory control unit 12A illustrated in FIG. 1 by executing the shared memory control process 62A. The cores 211, 212 also operate as the address map translation unit 14 illustrated in FIG. 1 by executing the address map translation process 64.

The physical machine 30A includes a CPU chip 31P including a core 311, a core 312, and a local memory 321, and a CPU chip 31Q including a core 313, a core 314, and a local memory 322. A core 31n may directly access a local memory 32n mounted in the same chip, and the shared memory 42.

The physical machine 30A also includes a nonvolatile storage unit 71, a communication I/F 72, and a R/W unit 73. CPU chips 31P, 31Q, the storage unit 71, the communication I/F 72, and the R/W unit 73 are coupled with each other via a bus.

The storage unit 71 may be implemented by HDD, SSD, or flash memory. The storage unit 71 as a storage medium stores a control program 80A executed during the live migration of the virtual machine. The control program 80A includes a shared memory control process 86A and an address map translation process 88.

Cores 311, 312 allocated to the virtual machine 35 as a control domain reads the control program 80A from the storage unit 71, develops the same on the local memory 321, and executes processes of the control program 80A sequentially. Cores 311, 312 operate as a shared memory control unit 16A illustrated in FIG. 1 by executing the shared memory control process 86A. Cores 311, 312 also operate as the address map translation unit 18 illustrated in FIG. 1 by executing the address map translation process 88.

The shared memory 42 may be implemented by a recording medium coupled with each of the physical machine 20A and physical machine 30A via interconnection. For example, the shared memory 42 may be configured in a storage area within a physical machine 40 which is separate from the physical machine 20A and physical machine 30A. The shared memory 42 may be an external storage device or potable storage medium, which is separate from the physical machine 20A and physical machine 30A.

Functions implemented by control programs 60A, 80A also may be implemented, for example, by a semiconductor integrated circuit, or more specifically, by an application specific integrated circuit (ASIC) or the like.

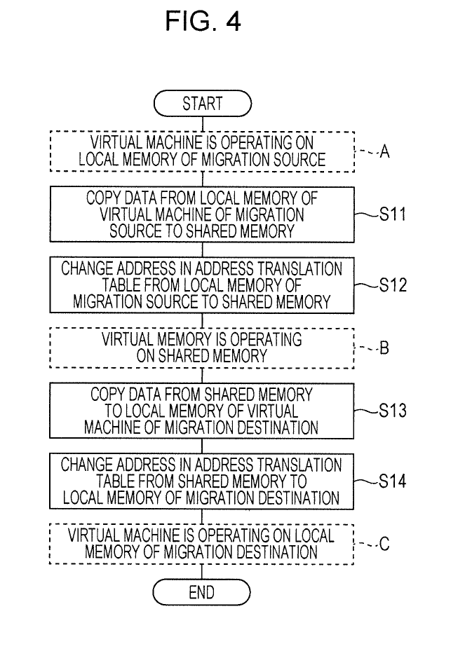

Next, functions of the control system 10A according to the first embodiment are described. First, outline of entire the live migration processing executed by the control system 10A is described with reference to FIG. 4.

In a state A prior to start of the live migration, a virtual machine 27 being the target of the live migration operates on the local memory 222 of the physical machine 20A allocated to the virtual machine 27.

When the live migration is started, in the step S11, the hypervisor 23 copies data stored in the local memory 222 to a shared memory 42 for each of entries. Then, in the step S12, the address map translation unit 14 changes the physical address of copied entries to the address of the shared memory 42 of the copy destination. Thus, updating processing to the address indicated by copied entries is performed to the shared memory 42.

Upon completion of copying of the data from the local memory 222 to the shared memory 42 for all entries, the virtual machine 27 is put in a state B where the virtual machine 27 operates on the shared memory 42. In this state, control is changed over from the virtual machine 27 of the migration source to the virtual machine 37 of the migration destination. At that time, the address translation table 34 referred to by the hypervisor 33 of the migration destination is the same as the address translation table 24 of the migration source. Therefore, the virtual machine 37 of the migration destination is also put in the state B in which the virtual machine 37 operates on the shared memory 42.

Next, in the step S13, the hypervisor 33 copies data stored in the shared memory 42 to the local memory 322 for each of entries. Then, in the step S14, the address map translation unit 18 changes the physical address of copied entries to the address of the local memory 322 of the copy destination. Thus, updating processing to the address indicated by copied entries is performed to the local memory 322.

Upon completion of copying of the data from the shared memory 42 to the local memory 322 for all entries, the virtual machine 37 is put in a state C where the virtual machine 37 operates on the local memory 322.

Thus, by using the shared memory 42 as a memory transfer path during the live migration, the live migration may be implemented without suspending the virtual machine.

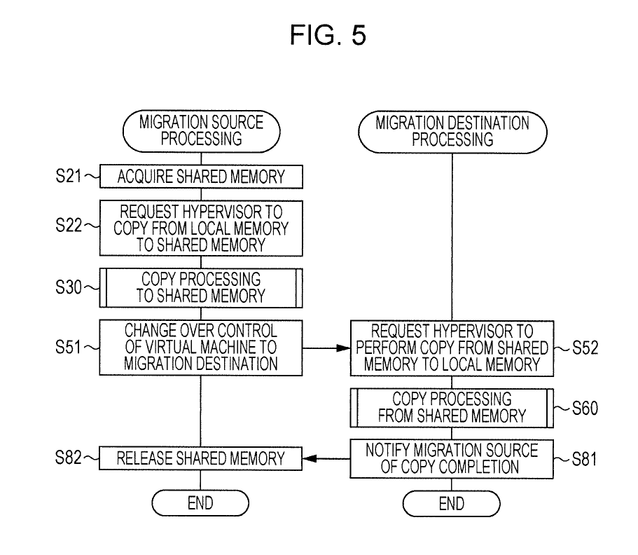

Next, migration source processing executed by the physical machine 20A of the migration source and migration destination processing executed by the physical machine 30A of the migration destination in the live migration is described more in detail with reference to FIG. 5.

When start of the live migration is instructed, in the step S21, the shared memory control unit 12A acquires, on the shared memory 42, a memory area of the same size as the local memory 222 allocated to the virtual machine 27.

Next, in the step S22, the shared memory control unit 12A notifies the hypervisor 23 of the physical address of the acquired memory area of the shared memory 42 and requests the hypervisor 23 to copy the data from the local memory 222 to the shared memory 42.

Next, in the step S30, the shared memory control unit 12A waits for the completion of “copy processing to the shared memory” executed by the hypervisor 23 using the dirty page tracking function.

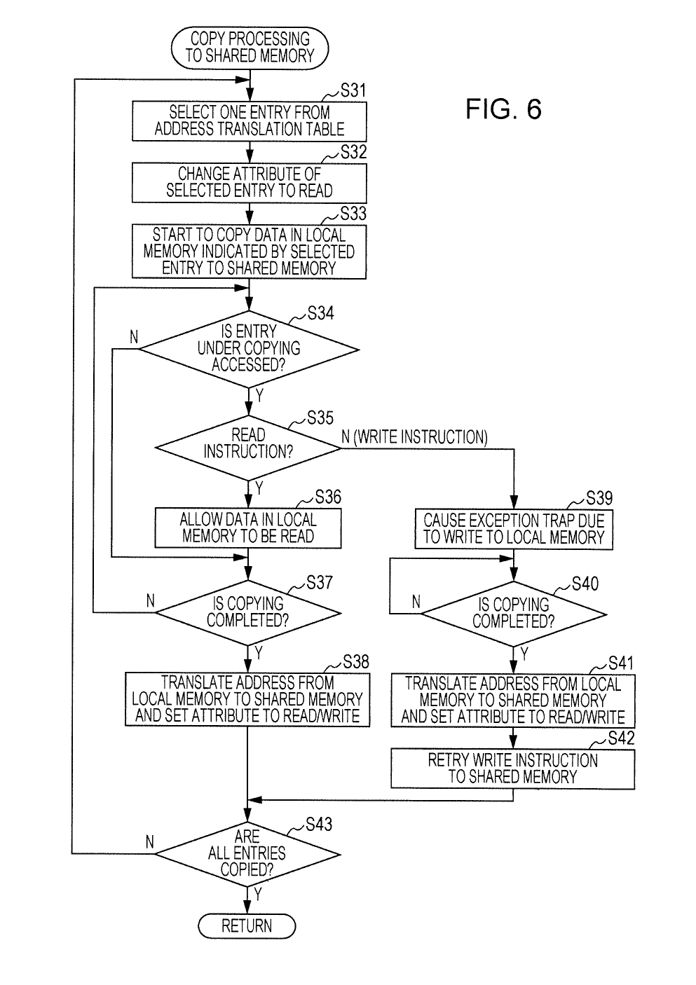

Here, the copy processing to the shared memory is described with reference to FIG. 6.

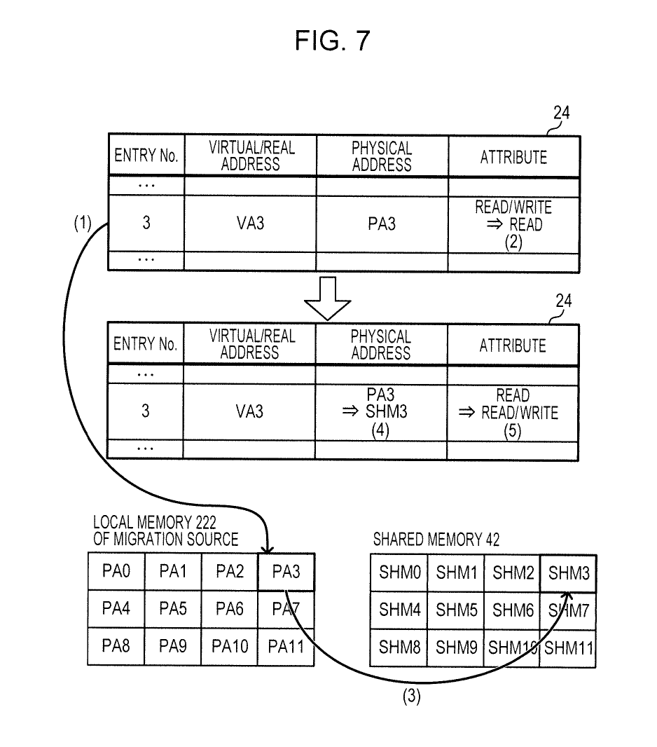

In the step S31, the address map translation unit 14 selects one entry matched with the physical address notified of from the shared memory control unit 12A out of the entries included in the address translation table 24. For example, it is assumed that as illustrated in FIG. 7, an entry No.3 is selected from the address translation table 24 illustrated in FIG. 2 ((1) of FIG. 7). It is assumed that as illustrated on the lower left side of FIG. 7, the entry No.3 corresponds to a block indicated by a physical address “PA3” of the local memory 222 on the physical machine 20A of the migration source.

Next, in the step S32, the address map translation unit 14 changes the attribute of the entry selected in the address translation table 24 to the attribute “READ” allowing only reading ((2) of FIG. 7).

Next, in the step S33, the hypervisor 23 starts to copy the data of the local memory 222 corresponding to the selected entry to the shared memory 42 ((3) of FIG. 7).

Next, in the step S34, the hypervisor 23 determines whether there is an access from the core 213 or core 214 to the block of the local memory 222 corresponding to the selected entry or to a block to which data is being copied. When there is an access, processing proceeds to the step S35, and when there is no access, processing proceeds to the step S37.

In the step S35, processing is branched depending on whether access from the core 213 or 214 is the READ instruction. When the access is the READ instruction, the READ instruction is executed to the local memory 222 in the next step S36.

Next, in the step S37, the hypervisor 23 determines whether copying started in the step S33 has completed. When the copying has not yet completed, processing returns to the step S34. When the copying has completed, processing proceeds to the step S38.

In the step S38, the address map translation unit 14 changes the physical address of the entry selected in the step S31 from the address of the local memory 222 to the address of the shared memory 42 of the copy destination ((4) of FIG. 7). Also, the address map translation unit 14 changes the attribute of the corresponding entry to the address “READ/WRITE” allowing reading and writing ((5) of FIG. 7).

Meanwhile, when determination in the step S35 is negative, the access from the core 213 or core 214 is the WRITE instruction. In this case, in the step S39, the WRITE instruction to the block of the local memory 222 indicated by an entry whose attribute is “READ” causes a trap. With this trap, the hypervisor 23 detects that the WRITE instruction to the block of the local memory 222 indicated by the entry being copied has been issued.

Then, the hypervisor 23 temporarily suspends the WRITE instruction and, in the step S40, waits until copying of the corresponding entry completes. Upon completion of the copying, in the next step S41, the address map translation unit 14 changes the physical address of the selected entry from the address of the local memory 222 to the address of the shared memory 42 of the copy destination ((4) of FIG. 7) as in the step S38. Also, the address map translation unit 14 changes the attribute of the corresponding entry from “READ” to “READ/WRITE” ((5) of FIG. 7).

Next, in the step S42, the hypervisor 23 retries (re-executes) the WRITE instruction temporarily suspended due to occurrence of the trap. The WRITE instruction to be retried is executed to the shared memory 42 in accordance with the address translation table 24 re-written by the address map translation unit 14.

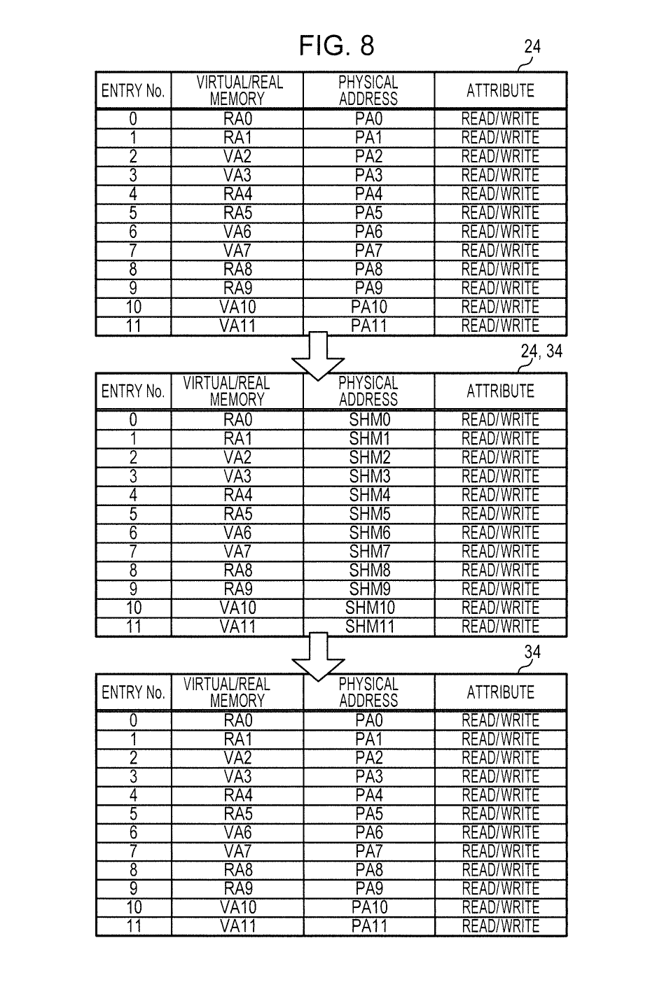

Next, in the step S43, the address map translation unit 14 determines whether all entries corresponding to the physical address notified of from the shared memory control unit 12A have been copied to the shared memory 42. When there exists an entry not yet copied, processing returns to the step S31, and the entry not yet copied is selected. Then, processing of steps S32 to S42 is repeated. When copying of all entries has completed, the copy processing to the shared memory ends, and processing returns to the migration source processing illustrated in FIG. 5. Upon completion of copying of all entries, the address translation table 24 is translated, for example, from a state depicted at the top of FIG. 8 to a state depicted at the middle of FIG. 8.

The copy processing to the shared memory in steps S32 to S42 is executed for every entry. Therefore, entries not selected presently in the address translation table 24 have the attribute of “READ/WRITE”. Thereby, access from the core 213 or core 214 is executed without a trap irrespective of the READ instruction or WRITE instruction. In this processing, for the entry not yet copied to the shared memory 42, the corresponding block of the local memory 222 is accessed. Meanwhile, when copying to the shared memory 42 has completed, the corresponding block of the shared memory 42 is accessed, as the physical address has been rewritten to the address of the shared memory 42 in the step S38 or S41. That is, dirty page tracking is performed only for the block being copied.

Proceeding returns to the migration source processing illustrated in FIG. 5. In the step S51, a virtualization management software 26 of the migration source transmits the address translation table 24 subjected to processing of the step S30 to a virtualization management software 36 of the migration destination, and notifies the virtualization management software 36 of changeover of the control of the virtual machine. The virtualization management software 36 of the migration destination sets the received address translation table 24 to the address translation table 34 referred to by the hypervisor 33 of the physical machine of the migration destination, and causes the virtual machine 37 to operate on the shared memory 42. Thus, control of the virtual machine is changed over from the migration source to the migration destination.

Next, in the step S52 of the migration destination processing, the shared memory control unit 16A requests the hypervisor 33 to copy data from the shared memory 42 to the local memory 322.

Next, in the step S60, the shared memory control unit 16A stands by for completion of “copy processing from the shared memory” that is executed by the hypervisor 33 using the dirty page tracking function.

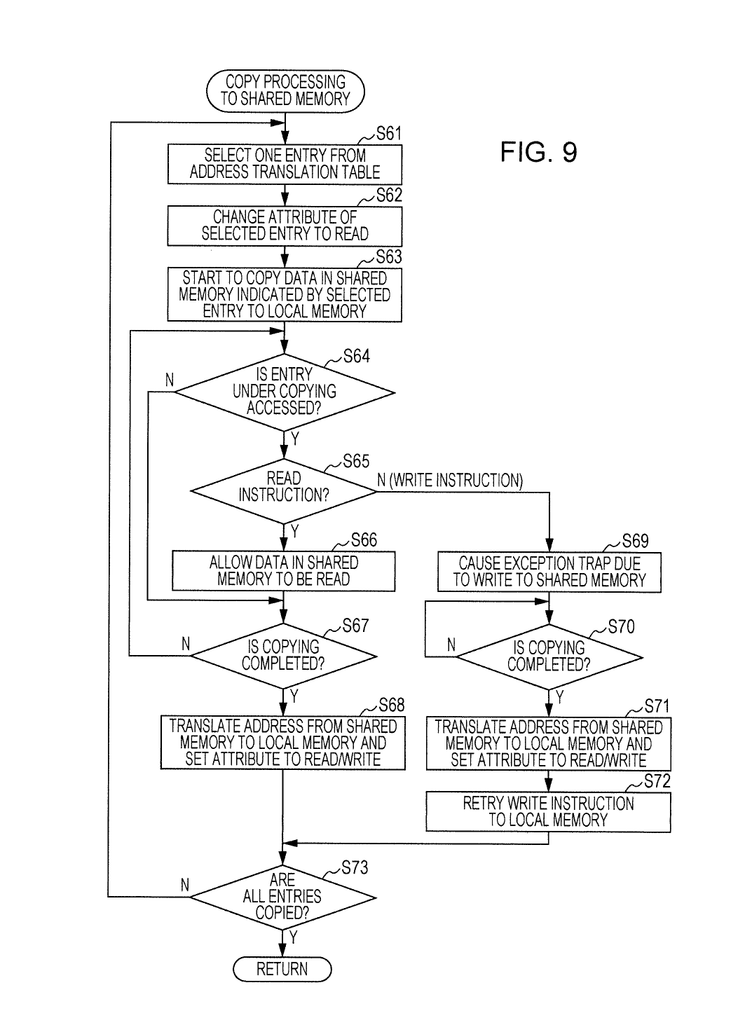

Here, copy processing from the shared memory is described with reference to FIG. 9.

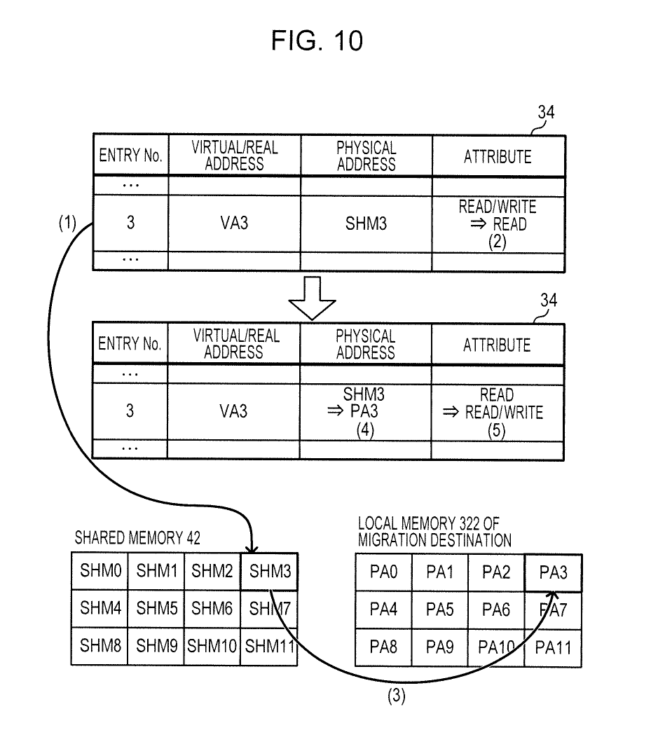

In the step S61, the address map translation unit 18 selects, from the address translation table 34, one entry corresponding to a block to which data has to be copied from the shared memory 42 to the local memory 322. The entry corresponding to the block to which data has to be copied is an entry set into the address translation table 34 of the migration destination based on the address translation table 24 acquired from the migration source. For example, it is assumed that as illustrated in FIG. 10, an entry No.3 is selected from the address translation table 34 depicted at the middle of FIG. 8 ((1) of FIG. 10). It is assumed that as illustrated on the lower left side of FIG. 10, the entry No.3 corresponds to a block indicated by a physical address “SHM3” of the shared memory 42.

Next, in the step S62, the address map translation unit 18 changes the attribute of the entry selected in the address translation table 34 to “READ” ((2) of FIG. 10).

Next, in the step S63, the hypervisor 33 starts to copy data of the shared memory 42 corresponding to the selected entry to the local memory 322 ((3) of FIG. 10).

Next, in the step S64, the hypervisor 23 determines whether there is an access from the core 313 or core 314 to the block of the local memory 222 corresponding to the selected entry. When there is an access, processing proceeds to the step S65, and when there is no access, processing proceeds to the step S67.

In the step S65, processing is branched depending on whether access from the core 313 or core 314 is the READ instruction. When the access is the READ instruction, the READ instruction is executed to the local memory 222 in the next step S66.

Next, in the step S67, the hypervisor 23 determines whether copying of the selected entry has completed. When the copying has not yet completed, processing returns to the step S64. When the copying has completed, processing proceeds to the step S68.

In the step S68, the address map translation unit 18 changes the physical address of the entry selected in the step S61 from the address of the shared memory 42 to the address of the local memory 322 of the copy destination ((4) of FIG. 10). Also, the address map translation unit 18 changes the attribute of the corresponding entry from “READ” to “READ/WRITE” ((5) of FIG. 10).

Meanwhile, when determination in the step S65 is negative or the WRITE instruction, in the step S69, the WRITE instruction to the block corresponding to the entry whose attribute is “READ” causes a trap. With this trap, the hypervisor 33 detects that the WRITE instruction to the block of the shared memory 42 indicated by the entry being copied has been issued.

Then, the hypervisor 33 temporarily suspends the WRITE instruction and, in the step S70, waits until the copying of the corresponding entry completes. Upon completion of the copying, in the next step S71, the address map translation unit 18 changes, as in the step S68, the physical address of the selected entry from the address of the shared memory 42 to the address of the local memory 322 of the copy destination ((4) of FIG. 10). Also, the address map translation unit 18 changes the attribute of the corresponding entry from “READ” to “READ/WRITE” ((5) of FIG. 10).

Next, in the step S72, the hypervisor 33 retries the WRITE instruction temporarily suspended due to occurrence of the trap.

Next, in the step S73, the address map translation unit 18 determines whether all entries in the address translation table 34 which have to be copied have been copied to the local memory 322. When there exists an entry not yet copied, processing returns to the step S61, and the entry not yet copied is selected. Then, processings of steps S62 to S72 are repeated. When the copying of all entries has completed, the copy processing from the shared memory ends, and processing returns to the migration destination processing illustrated in FIG. 5. Upon completion of copying of all entries, the address translation table 34 is translated, for example, from a state depicted at the middle of FIG. 8 to a state depicted at the bottom of FIG. 8.

Next, in the step S81 of the migration destination processing illustrated in FIG. 5, the virtualization management software 36 of the migration destination notifies the virtualization management software 26 of the migration source of completion of copying from the shared memory 42 to the local memory 322. Then, the migration destination processing ends.

Upon receiving the notification, in the step S82, the shared memory control unit 12A of the migration source determines that use of the shared memory 42 has completed and releases the memory area of the shared memory 42 acquired in the step S21. Then, the migration source processing ends.

As described above, the control system 10A according to the first embodiment provides a shared memory accessible from both the physical machine of the migration source and the physical machine of the migration destination. Then, data of the local memory of the migration source is copied into the shared memory, and access destination is changed to the shared memory. As the physical machine of the migration source may directly access to the shared memory as well, copied data may be accessed through the shared memory. Therefore, the virtual machine does not have to be suspended. After all data has been copied from the local memory of the migration source to the shared memory, control of the virtual machine is changed over to the migration destination. Then, data of the shared memory is copied into a local memory of the migration destination, and access destination is changed to the local memory of the migration destination. As the physical machine of the migration destination may directly access to the shared memory as well, data not yet copied may be accessed through the shared memory. Therefore, no suspension of the virtual machine is requested. Thus, data is copied from a local memory of the migration source to a local memory of the migration destination via a shared memory accessible from both the migration source and migration destination. Thus, the live migration may be executed without suspending the virtual machine.

As the live migration may be executed without suspending the virtual machine, maintenance works such as replacement of a defective part may be performed without stopping a service of a virtual machine operating on the physical machine due to the maintenance of the physical machine.

The control system 10A according to the first embodiment performs copying and address translation from a local memory of the migration source to a shared memory for each of blocks divided from the memory area. Thus, the WRITE instruction is executed to a local memory of the migration source for a block not yet copied and to a shared memory for a copied block. Likewise, when copying from the shared memory to the local memory of the migration destination, the WRITE instruction is executed to the shared memory for a block not yet copied, and to the local memory of the migration destination for a copied block. When the WRITE instruction is issued to a block being copied, the WRITE instruction is suspended until completion of copying, and then the WRITE instruction is retried after completion of copying. Thus, copying between the local memory and shared memory completes in one time for the same block definitely. Therefore, no processing such as repeating of copying is requested, until the memory state is synchronized between the local memory and shared memory.

In a case where the WRITE instruction is issued to a block being copied, processing of suspending the WRITE instruction until completion of copying is a simple processing compared with a processing of suspending the virtual machine executed by the OS, and the suspension time is shorter. Smaller the size of each block divided from the memory area, shorter the time until completion of copying of each block and lower the probability that the WRITE instruction is issued to the block during copying. Thus, effects by suspension of the WRITE instruction may be reduced. For example, size of each block may be a minimum size (for example, 4 kB or 8 kB) of the memory manageable by the OS.

The control system 10A according to the first embodiment does not have to suspend the virtual machine during the live migration, and therefore, does not have to detect the dirty ratio that is one of factors for the overhead of the live migration. Consequently, this improves the speed of the live migration processing.

### SECOND EMBODIMENT

Next, a second embodiment is described. In the second embodiment, a case where a shared memory is provided among nodes in a physical memory of the physical machine of the migration source is described. In a control system according to the second embodiment, detailed description of parts identical with those of the control system 10A according to the first embodiment is omitted by assigning same reference numerals.

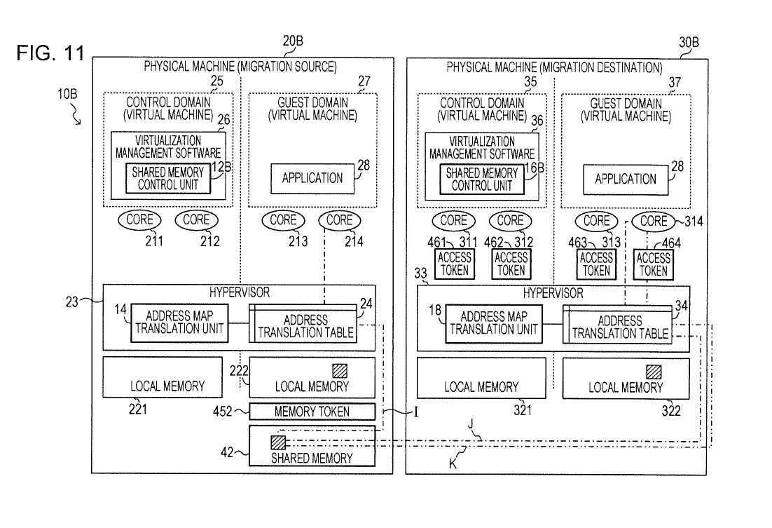

FIG. 11 schematically illustrates a functional configuration of a control system 10B according to the second embodiment, along with a relevant hardware configuration. As illustrated in FIG. 11, the control system 10B according to the second embodiment includes a physical machine 206 of the migration source and a physical machine 30B of the migration destination. A part of the physical memory of the physical machine 20B of the migration source is utilized as a shared memory 42. In FIG. 11, an example that a part of the physical memory allocated to the virtual machine 27 is used as a shared memory 42 is depicted.

The virtualization management software 26 of the migration source incorporates therein a shared memory control unit 12B. Like the shared memory control unit 12A in the first embodiment, the shared memory control unit 12B controls acquisition and release of the shared memory 42.

The shared memory control unit 12B sets, for each of shared memories, a memory token 45n (in FIG. 11, n=2) for controlling access to the shared memory 42 provided in the physical machine 20B of the migration source. In FIG. 11, an example that a memory token 452 is set to the shared memory 42 is depicted. The shared memory control unit 12B generates an access token 46n (in FIG. 11, n=1, 2, 3, 4) to be paired with a memory token 45n and transmits the same to another node that accesses to a shared memory 42 to which the memory token 45n is set.

The virtualization management software 36 of the migration destination incorporates therein a shared memory control unit 16B. Like the shared memory control unit 16A in the first embodiment, the shared memory control unit 16B notifies a shared memory control unit 12B of the migration source of completion of copying of data from a shared memory 42 to a local memory 32n in the live migration.

The shared memory control unit 16B acquires an access token 46n used for access to the shared memory 42 and sets the same in association with a core 31n accessing to the shared memory 42. FIG. 11 depicts an example that each of access tokens 461, 462, 463, and 464 to be paired with the memory token 452 set to the shared memory 42 is set in association with each of cores 311, 312, 313, and 314 of the migration destination.

When accessing to a shared memory provided therein, each node may directly access to the shared memory without the access token 46n. Meanwhile, when accessing to a shared memory 42 provided in another node, the access token 46n is requested.

For example, in FIG. 11, the core 214 allocated to a virtual machine 27 may directly access to the shared memory 42 provided therein without setting the access token (one-dot broken line I of FIG. 11). Assume that a core 314 allocated to a virtual machine 37 of another node directly accesses to the shared memory 42 (one-dot broken line J of FIG. 11). In this case, access is refused since an access token 464 to be paired with a memory token 452 set to the shared memory 42 is not used for the access. Meanwhile, assume that the access token 464 to be paired with the memory token 452 is set to the core 314, and the core 314 accesses to the shared memory 42 by using the access token 464 (double-dot broken line K of FIG. 11). In this case, access from the core 314 to the shared memory 42 is allowed since the memory token 452 and the access token 464 are associated with each other.

The shared memory control unit 12B is an example of the first control unit of the disclosed technique, and the shared memory control unit 16B is an example of the second control unit of the disclosed technique.

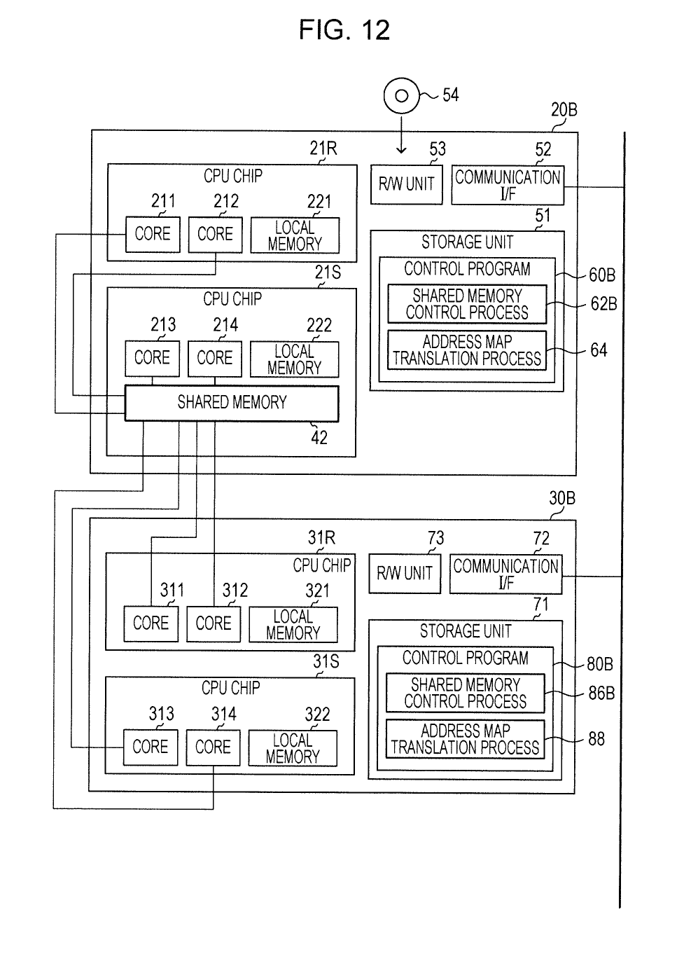

FIG. 12 is a schematic view of a hardware configuration of the control system 10B according to the second embodiment.

The physical machine 20B includes a CPU chip 21R including a core 211, a core 212, and a local memory 221, and a CPU chip 21S including a core 213, a core 214, a local memory 222, and a shared memory 42. The physical machine 20B also includes a nonvolatile storage unit 51, a communication I/F 52, and an R/W unit 53. CPU chips 21R and 21S, storage unit 51, communication I/F 52, and R/W unit 53 are coupled with each other via a bus.

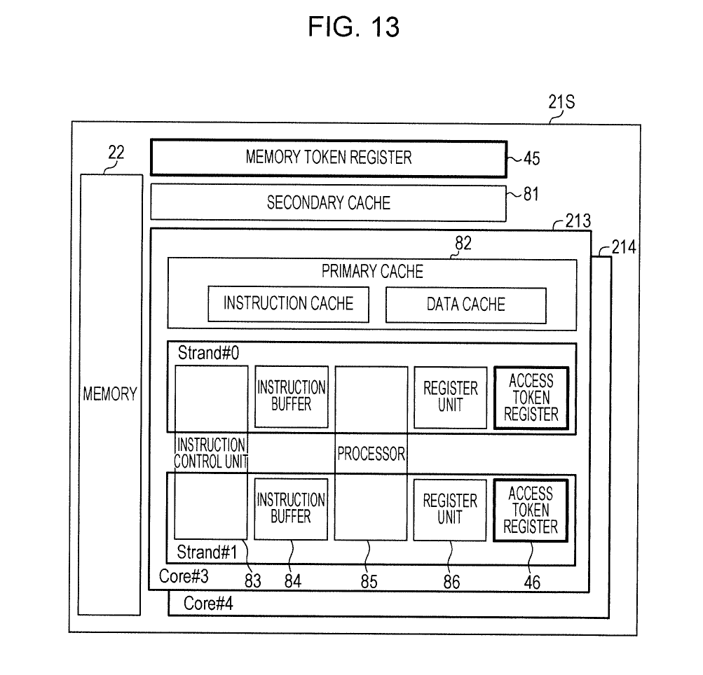

CPU chips 21R, 21S are described more in detail with reference to FIG. 13. As both CPU chips have the same configuration, the CPU chip 21S is described here.

The CPU chip 21S includes a memory 22, a memory token register 45, a secondary cache 81, and cores 213, 214. An area of the memory 22 is used as a local memory 222, and another area thereof is used as a shared memory 42. A value indicating the memory token 452 corresponding to the shared memory 42 is set to the memory token register 45. The shared memory 42 has a plurality of segments. When access propriety is controlled for each of the segments, a memory token 45n is also set for each of the segments. Thus, a plurality of memory token registers 45 may be prepared in advance in order to set the memory token 45n for each of the segments.

The core 213 includes, for each strand, a first level cache 82 including an instruction cache and a data cache, an instruction control unit 83, an instruction buffer 84, a processor 85, a register unit 86, and an access token register 46. The instruction control unit 83 and processor 85 are shared by respective strands. A value indicating an access token 46n for access to a shared memory 42 provided in another node is set to the access token register 46. The core 214 has the same configuration.

Based on a memory token set to the memory token register 45 and an access token set to the access token register 46, access propriety to the shared memory 42 may be controlled by hardware.

Back to FIG. 12, the storage unit 51 stores a control program 60B executed during the live migration of the virtual machine. The control program 60B includes a shared memory control process 62B and an address map translation process 64.

Cores 211, 212 allocated to the virtual machine 25 as a control domain reads the control program 60B from the storage unit 51, develops the same on the local memory 221, and executes processes of the control program 60B sequentially. Cores 211, 212 operate as the shared memory control unit 12B illustrated in FIG. 11 by executing the shared memory control process 62B. The address map translation process 64 is the same as the first embodiment.

The physical machine 30B includes a CPU chip 31R including a core 311, a core 312, and a local memory 321, and a CPU chip 31S including a core 313, a core 314, and a local memory 322. Configuration of CPU chips 31R, 31S is the same as configuration of the CPU chip 21S illustrated in FIG. 13. The physical machine 30B also includes a nonvolatile storage unit 71, a communication I/F 72, and an R/W unit 73. CPU chips 31R and 31S, the storage unit 71, the communication I/F 72, and the R/W unit 73 are coupled with each other via a bus.

The storage unit 71 stores a control program 808 executed during the live migration of the virtual machine. The control program 80B includes a shared memory control process 86B and an address map translation process 88.

Cores 311, 312 allocated to the virtual machine 35 as a control domain read the control program 808 from the storage unit 71, develop the same on the local memory 321, and execute processes of the control program 808 sequentially. Cores 311, 312 operate as a shared memory control unit 16B illustrated in FIG. 11 by executing the shared memory control process 86B. The address map translation process 88 is the same as the first embodiment.

Functions implemented by control programs 60B, 80B also may be implemented, for example, by a semiconductor integrated circuit, or more specifically, by ASIC or the like.

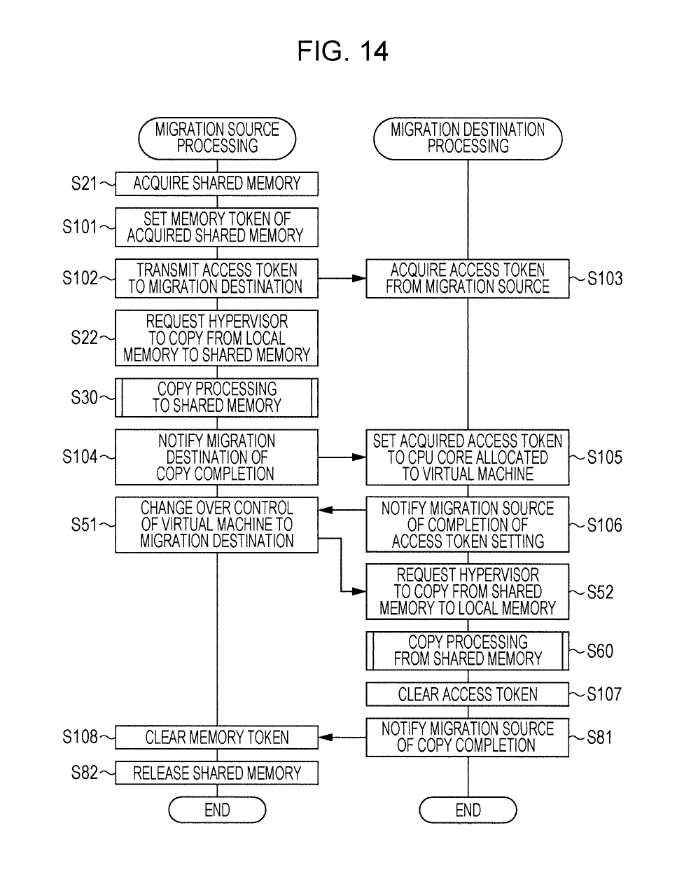

Next, functions of the control system 10B according to the second embodiment are described with reference to the migration source processing and migration destination processing illustrated in FIG. 14. Detailed description of processings similar with the migration source processing and migration destination processing (FIG. 5) in the first embodiment is omitted by assigning same reference numerals.

When start of the live migration is instructed, in the step S21, the shared memory control unit 12B acquires the memory area of the shared memory 42 on a physical memory of the physical machine 20B.

Next, in the step S101, the shared memory control unit 12B sets a value indicating a memory token 45n corresponding to the acquired shared memory 42 to a memory token register 45 corresponding to the acquired shared memory 42.

Next, in the step S102, the shared memory control unit 12B generates an access token 46n to be paired with the memory token 45n and transmits the access token 46n to the virtualization management software 36 of the migration destination.

Next, in the step S103 of the migration destination processing, a shared memory control unit 16B of the migration destination acquires the access token 46n transmitted from the migration source.

Meanwhile, in the step S22 of the migration source processing, the shared memory control unit 12B requests the hypervisor 23 to copy data from the local memory 222 to the shared memory 42.

Next, in the step S30, the shared memory control unit 12B stands by for completion of “copy processing to the shared memory (FIG. 6)” which is executed by the hypervisor 23 using the dirty page tracking function.

Upon completion of copy of all entries from the local memory 222 to the shared memory 42, processing proceeds to the next step S104. In the step S104, the shared memory control unit 12B notifies the virtualization management software 36 of the migration destination of completion of copying from the local memory 222 to the shared memory 42.

Upon receiving this notification, in the step S105 of the migration destination processing, the shared memory control unit 16B sets the access token 46n acquired in the step S103 to an access token register 46 of a corresponding core 31n. For example, each of access tokens 461, 462, 463, and 464 is set to an access token register 46 corresponding to each of cores 311, 312, 313, and 314 allocated to the virtual machine 37. Thus, access from the core 31n to the shared memory 42 becomes available by using the set access token 46n.

Next, in the step S106, the shared memory control unit 16B notifies the virtualization management software 26 of the migration source of completion of setting of the access token.

Upon receiving this notification, in the step S51 of the migration source processing, the virtualization management software 26 of the migration source changes over control of the virtual machine from the migration source to the migration destination.

Next, in the step S52 of the migration destination processing, the shared memory control unit 16B requests the hypervisor 33 to copy data from the shared memory 42 to the local memory 322. Then, in the next step S60, the shared memory control unit 16B stands by for completion of “copy processing from the shared memory (FIG. 9)” which is executed by the hypervisor 33 using the dirty page tracking function.

Upon completion of copy of all entries from the shared memory 42 to the local memory 322, processing proceeds to the next step S107. In the step S107, the shared memory control unit 16B clears the access token 46n set to the access token register 46 for access to the shared memory 42.

Next, in the step S81, the virtualization management software 36 of the migration destination notifies the virtualization management software 26 of the migration source of completion of copying from the shared memory 42 to the local memory 322, and the migration destination processing ends.

Upon receiving this notification, in the step S108, the shared memory control unit 12B of the migration source clears the memory token 45n set to the memory token register 45 corresponding to the shared memory 42.

Next, in the step S82, the shared memory control unit 12B releases the shared memory 42 acquired in the step S21. Then, the migration source processing ends.

As described above, the control system 10B according to the second embodiment controls access propriety to a shared memory among nodes by using the memory token and the access token. Thus, a shared memory may be provided in a physical memory of the migration source which is not directly accessible from a physical machine of the migration destination. In this case, the live migration also may be executed without suspending the virtual machine as in the first embodiment.

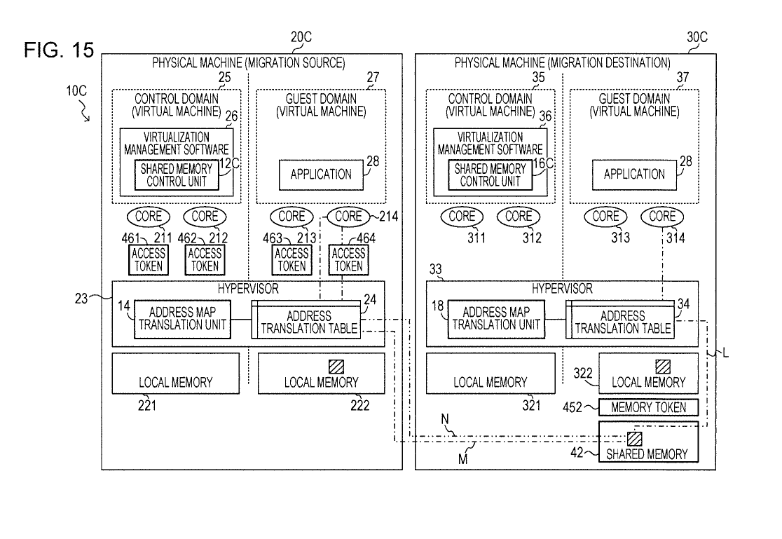

In the second embodiment, the shared memory is provided in a physical machine of the migration source. However, the shared memory may be provided in a physical machine of the migration destination. This case is represented by a control system 10C according to a modified example of the second embodiment. A functional configuration of the control system 10C is schematically illustrated in FIG. 15 along with a relevant hardware configuration.

As illustrated in FIG. 15, the control system 10C according to the modified example of the second embodiment includes a physical machine 20C of the migration source and a physical machine 30C of the migration destination. A part of the physical memory in the physical machine 30C of the migration destination is utilized as a shared memory 42. In FIG. 15, an example that a part of the physical memory allocated to the virtual machine 37 is used as the shared memory 42 is depicted.

In this case, for example, the core 314 allocated to the virtual machine 37 may directly access to the shared memory 42 provided therein without setting an access token (one-dot broken line L of FIG. 15). Assume that a core 214 allocated to a virtual machine 27 of another node directly accesses the shared memory 42 (one-dot broken line M of FIG. 15). In this case, access is refused since an access token 464 to be paired with a memory token 452 set to the shared memory 42 is not used for the access. Meanwhile, assume that the access token 464 to be paired with the memory token 452 is set to the core 214, and the core 214 accesses the shared memory 42 by using the access token 464 (double-dot broken line N of FIG. 15). In this case, access from the core 214 to the shared memory 42 is allowed since the memory token 452 and the access token 464 are associated with each other.

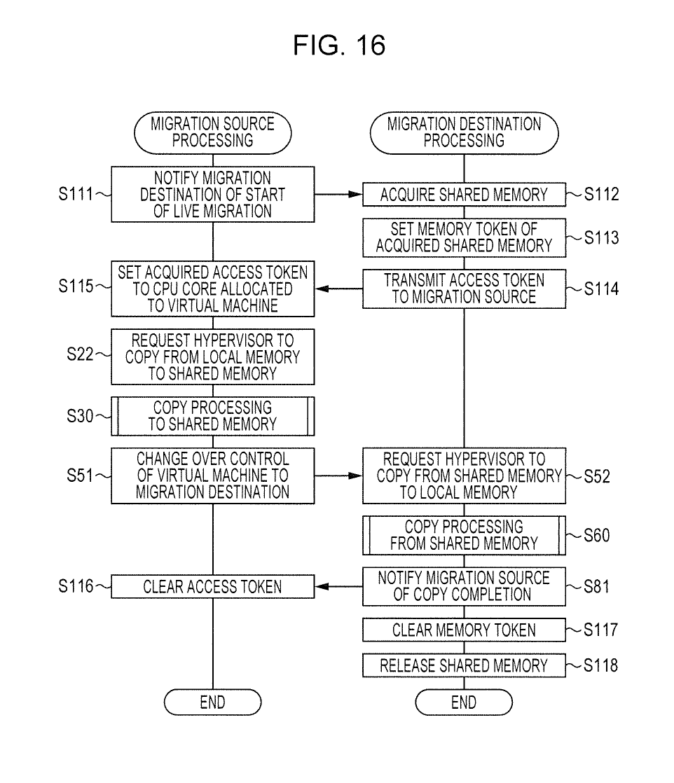

Next, functions of the control system 10C according to the modified example of the second embodiment are described with reference to the migration source processing and migration destination processing illustrated in FIG. 16. Detailed description of processings similar with the migration source processing and migration destination processing (FIG. 5) in the first embodiment is omitted by assigning same reference numerals.

When start of the live migration is instructed, in the step S111, a virtualization management software 26 of the migration source notifies a virtualization management software 36 of the migration destination of the start of the live migration.

Upon receiving this notification, in the step S112 of the migration destination processing, a shared memory control unit 16C of the migration destination acquires the memory area of the shared memory 42 on a physical memory of the physical machine 30C.

Next, in the step S113, the shared memory control unit 16C sets a value indicating a memory token 45n corresponding to the acquired shared memory 42 to a memory token register 45 corresponding to the acquired shared memory 42.

Next, in the step S114, the shared memory control unit 16C generates an access token 46n to be paired with the memory token 45n and transmits the access token 46n to the virtualization management software 26 of the migration source.

Next, in the step S115 of the migration source processing, the shared memory control unit 12C of the migration source acquires the access token 46n transmitted from the migration destination, and sets to an access token register 46 of a corresponding core 21n. For example, each of access tokens 461, 462, 463, and 464 is set to an access token register 46 corresponding to each of the cores 211, 212, 213, and 214 allocated to the virtual machine 27. Thus, access from the core 21n to the shared memory 42 becomes available by using the set access token 46n.

Next, in the step S22, the shared memory control unit 12C requests the hypervisor 23 to copy data from the local memory 222 to the shared memory 42. Next, in the step S30, the shared memory control unit 12C stands by for completion of “copy processing of copying to the shared memory (FIG. 6)” which is executed by the hypervisor 23 using the dirty page tracking function.

Upon completion of the copying of all entries from the local memory 222 to the shared memory 42, in the next step S51, the virtualization management software 26 of the migration source changes over control of the virtual machine from the migration source to the migration destination.

Next, in the step S52 of the migration destination processing, the shared memory control unit 16C requests the hypervisor 33 to copy data from the shared memory 42 to the local memory 322. Then, in the next step S60, the shared memory control unit 16C stands by for completion of “copy processing from the shared memory (FIG. 9)” which is executed by the hypervisor 33 using the dirty page tracking function.

Upon completion of the copying of all entries from the shared memory 42 to the local memory 322, processing proceeds to the step S81. In the step S81, the virtualization management software 36 of the migration destination notifies the virtualization management software 26 of the migration source of completion of copying from the shared memory 42 to the local memory 322.

Upon receiving this notification, in the step S108, the shared memory control unit 12C of the migration source clears the access token 46n set to the access token register 46 for access to the shared memory 42, and the migration source processing ends.

Meanwhile, in the next step S117, the shared memory control unit 16C of the migration destination clears the memory token 45n set to the memory token register 45 corresponding to the shared memory 42. Next, in the step S118, the shared memory control unit 16C releases the shared memory 42 acquired in the step S112. Then, the migration destination processing ends.

As described above, even in a case where a shared memory is provided in a physical memory of the physical machine of the migration destination, the disclosed technique may be applied as in the second embodiment.

The shared memory control unit 12C is an example of the first control unit of the disclosed technique, and the shared memory control unit 16C is an example of the second control unit of the disclosed technique.

In the embodiments described above, data is copied from the local memory of the migration source to the local memory of the migration destination via the shared memory. However, it is not limited thereto. The disclosed technique may be applied even to a case where the virtual machine of the migration source operates on an external shared memory or a shared memory provided at the migration source. In this case, processings following completion of copying of all entries from the local memory of the migration source to the shared memory may be executed in the first and second embodiments. The disclosed technique also may be applied to a case where the virtual machine of the migration destination is resumed on a shared memory. In this case, the live migration may be terminated upon completion of copying of all entries to an external shared memory or a shared memory provided at the migration destination.

The above embodiments are described based on an aspect where control programs 60A, 60B, 80A, and 80B being an example of the control program according to the disclosed technique are stored (installed) into storage units 51, 71 in advance. However, it is not limited thereto. The control program according to the disclosed technique may be provided in a form stored into a storage medium such as CD-ROM, DVD-ROM, and USB memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process for migrating a virtual machine from a first physical machine to a second physical machine, the process comprising:
copying data stored in a first local memory of the first physical machine allocated to the virtual machine to a shared memory accessible from both of the first physical machine and the second physical machine, while translating a physical address for the virtual machine to access the copied data, from an address of the first local memory to an address of the shared memory;
upon completion of copying all data in the first local memory to the shared memory, changing over control of the virtual machine from the first physical machine to the second physical machine; and
copying data stored in the shared memory to a second local memory of the second physical machine allocated to the virtual machine, while translating a physical address for the virtual machine to access the copied data, from an address of the shared memory to an address of the second local memory.

2. The non-transitory, computer-readable recording medium of claim 1, the process further comprising:
when a write instruction to the data is issued during the copying of the data from the first local memory to the shared memory, suspending execution of the write instruction until the copying of the data to the shared memory completes, and executing the write instruction on the data copied on the shared memory after completion of the copying; and
when a write instruction to the data is issued during the copying of the data from the shared memory to the second local memory, suspending execution of the write instruction until the copying of the data to the second local memory completes, and executing the write instruction on the data copied on the second local memory after completion of the copying.

3. The non-transitory, computer-readable recording medium of claim 1, the process further comprising:
dividing an area of each of the first local memory, the second local memory, and the shared memory allocated to the virtual machine, into a plurality of blocks; and
performing, on a block-by-block basis, the copying of the data from the first local memory to the shared memory, the translating of the physical address from the first local memory to the shared memory, the copying of the data from the shared memory to the second local memory, and the translating of the physical address from the shared memory to the second local memory.

4. The non-transitory, computer-readable recording medium of claim 3, wherein a size of each block is a minimum size manageable by operating systems of the first physical machine and the second physical machine.

5. The non-transitory, computer-readable recording medium of claim 1, wherein the shared memory is provided in a storage area outside the first physical machine and the second physical machine.

6. The non-transitory, computer-readable recording medium of claim 1, wherein the shared memory is provided in a storage area included in the first physical machine or the second physical machine.

7. The non-transitory, computer-readable recording medium of claim 6, wherein
in a case where the shared memory is provided in a storage area included in the first physical machine, a memory token corresponding to the shared memory is set in the first physical machine, and an access token paired with the memory token for access to the shared memory is set in the second physical machine.

8. The non-transitory, computer-readable recording medium of claim 6, wherein
in a case where the shared memory is provided in a storage area included in the second physical machine, a memory token corresponding to the shared memory is set in the second physical machine, and an access token paired with the memory token for access to the shared memory is set in the first physical machine.

9. A system comprising:
a first physical machine including a first local memory and a first processor coupled to the first local memory;
a second physical machine including a second local memory and a second processor coupled to the second local memory; and
a shared memory accessible from both of the first physical machine and the second physical machine, wherein
the first processor of the first physical machine is configured to:
execute processing of copying data stored in the first local memory allocated to the virtual machine to the shared memory, and
translate a physical address for the virtual machine to access to the data copied from the first local memory to the shared memory, from an address of the first local memory to an address of the shared memory;
the second processor of the second physical machine is configured to:
when copying of all data in the first local memory to the shared memory completes and the first physical machine changes over control of the virtual machine from the first physical machine to the second physical machine, execute processing of copying the data stored in the shared memory to the second local memory allocated to the virtual machine, and
translate a physical address for the virtual machine to access the data copied from the shared memory to the second local memory, from an address of the shared memory to an address of the second local memory.

10. The system of claim 9, wherein
the first processor of the first physical machine is configured to, when a write instruction to data is issued during the copying of the data from the first local memory to the shared memory, cause the hypervisor of the first physical machine to suspend execution of the write instruction until the copying of the data into the shared memory completes, and to execute the write instruction on the data copied to the shared memory after completion of the copying; and
the second processor of the second physical machine is configured to, when a write instruction to the data is issued during the copying of the data from the shared memory to the second local memory, cause the hypervisor of the second physical machine to suspend execution of the write instruction until the copying of the data to the second local memory completes, and execute the write instruction on the data copied to the second local memory after completion of the copying.

11. The system of claim 9, wherein
an area of each of the first local memory, the second local memory, and the shared memory allocated to the virtual machine is divided into a plurality of blocks; and
the first processor of the first physical machine is configured to, on a block-by-block basis, execute processing of copying of the data from the first local memory to the shared memory, and translate a physical address from the first local memory to the shared memory; and
the second processor of the second physical machine is configured to, on a block-by-block basis, execute the processing of copying of the data from the shared memory to the second local memory, and translate a physical address from the shared memory to the second local memory.

12. The system of claim 11, wherein
the size of each block is a minimum size manageable by operating systems of the first physical machine and the second physical machine.

13. The system of claim 9, wherein
the shared memory is provided in a storage area outside the first physical machine and the second physical machine.

14. The system according of claim 9, wherein
the shared memory is provided in a storage area included in the first physical machine or the second physical machine.

15. The system of claim 14, wherein
in a case where the shared memory is provided in the storage area included in the first physical machine, the first processor sets a memory token corresponding to the shared memory in the first physical machine and transmits an access token paired with the memory token for access to the shared memory to the second physical machine, and the second processor sets the access token transmitted from the first processor in the second physical machine.

16. The system of claim 14, wherein
in a case where the shared memory is provided in the storage area include in the second physical machine, the second processor sets a memory token corresponding to the shared memory in the second physical machine and transmits an access token paired with the memory token for access to the shared memory to the first physical machine, and the first processor sets the access token transmitted from the second control unit in the first physical machine.

17. A method for migrating a virtual machine from a first physical machine to a second physical machine, the method comprising:
copying data stored in a first local memory of the first physical machine allocated to the virtual machine to a shared memory accessible from both of the first physical machine and the second physical machine, while translating a physical address for the virtual machine to access the copied data, from an address of the first local memory to an address of the shared memory;
upon completion of copying all data in the first local memory to the shared memory, changing over control of the virtual machine from the first physical machine to the second physical machine; and
copying data stored in the shared memory to a second local memory of the second physical machine allocated to the virtual machine, while translating a physical address for the virtual machine to access the copied data, from an address of the shared memory to an address of the second local memory.
